(19) United States
(12) Patent Application Publication
(10) Pub. No.: US 2026/0233805 A1
(43) Pub. Date: Aug. 13, 2026

(54) POWER ASSEMBLY FOR ELECTRIC-ASSISTED BICYCLE

(71) Applicant: Shihlin Electric & Engineering Corp., Taipei City (TW)

(72) Inventors: Tsung-Yu CHIANG, Taipei City (TW); Wei-Zhe ZHONG, Taipei City (TW)

(21) Appl. No.: 19/052,741

(22) Filed: Feb. 13, 2025

(51) Int. Cl. B62M 6/55; B62M 11/02

(52) U.S. Cl. CPC B62M 6/55; B62M 11/02

(57) ABSTRACT

A power assembly for electric-assisted bicycle integrates a motor, a reduction gear set and a driver. The power assembly includes a side cover, a driver, a motor drive housing, a motor stator, a motor rotor, a crankshaft, a reduction gear set, and a reduction gear housing. The driver is installed on the left side of the motor drive housing and covered and fixed by the side cover. The motor drive housing accommodates the motor stator and motor rotor in the right side thereof. The motor rotor drives a hollow input shaft center of the drive reduction gear set. The other side of the reduction gear set is covered with the reduction gear housing, which is assembled integrally with the motor drive housing. The crankshaft is inserted into each component of the power assembly and is located at axial center position of the power assembly.

### TECHNICAL FIELD

The present invention relates to a power assembly of an electric-assisted bicycle, and in particular to a power assembly of an electric-assisted bicycle where the power assembly can provide electric power used in conjunction with human power from user riding.

### DESCRIPTION OF RELATED ART

Bicycles are commonly-used tool for transportation of people nowadays. However, the bicycles are limited to only medium and short-distance riding because the forward momentum of bicycles require manual pedaling. The applicable travel range of the bicycles can be broadened in case that an auxiliary equipment is incorporated into the bicycle to provide additional forward momentum. Accordingly, electric bicycles with dual power from human power and motors are developed. In populous countries, especially in urban areas of those countries, riders frequently encounter the conditions of climbing uphill or needing to restart their bicycles after stopping by red lights. It demands lots of energy to climb a hill by driving bicycles or pedaling the bicycles to restart movement. The auxiliary power provided by the electric bicycles can reduce the effort of riders. Besides, due to lower effort, the riders can reach farther range with electric bicycles or carry heavier load with electric bicycles.

Motorcycle is another type of transportation tool nowadays, and electric bicycles have the advantages of compact size and light weight in comparison with motorcycle. In comparison with the bicycles pedaled by human beings only, electric bicycles equipped with motor power have the advantages of saving the rider's physical strength consumption and increasing the riding distance.

There are three types of electric-assisted bicycles available in the market: electric-assisted bicycles with front-drive, rear-drive and mid-drive motors. The mid-drive auxiliary power assembly become mainstream development in recent years. The main feature of the mid-drive auxiliary power assembly is that the motor power system is installed in the bottom bracket (BB) of the bicycle and the mid-drive auxiliary power assembly is in direct connection with the crank such that the rider can pedal the electric-assisted bicycle directly by himself or pedal the electric-assisted bicycle with auxiliary power from the mid-drive auxiliary power assembly. The weight of the mid-drive auxiliary power assembly is concentrated near the center of gravity of the bicycle. Therefore, it enhances the balance of the bicycle and reduces the relative resistance of the bicycle for pure manual pedaling. Besides, the motor can be optimized by adjusting with the mechanical transmission mechanism of the electric-assisted bicycle. The electric-assisted bicycle with mid-dive motor has advantages of good controllability, large torque and fast acceleration. Besides, front-to-rear balance can be achieved even when the vehicle is traveling fast. Therefore, the electric-assisted bicycle with mid-dive motor can be adapted to various road conditions. However, the bicycle frame is generally very simple, the conventional mid-drive auxiliary power assembly cannot be installed in certain bottom bracket demanding lightweight and compact space. The compact electric-assisted bicycle looks awkward when it is installed with conventional mid-drive auxiliary power assembly. Besides, lightweight is generally an important development trend in the market for the bicycle parts manufacturers. It is urgent needs to reduce the size and weight of the auxiliary power assembly.

Please refer to FIG. 1 and FIG. 1A, those drawings are perspective views and cross-sectional views of a related-art bicycle auxiliary power assembly for bicycle. As can be seen from the figures, the power assembly 10 integrates motor components, drives, and reduction gear to provide auxiliary power for assisting electric-assisted bicycle. Both ends of the crankshaft 16 are respectively connected to the crank of the bicycle and the pedal opposite to the crank with which user can pedal the bicycle manually. A left side cover 17 is arranged at the left side of the crankshaft 16 and is fixed by a plurality of left-side cover locking lugs 171 and a plurality of housing locking lugs 111 on the housing 11 with fastening screws. Within the housing 11, the driver 14, the motor stator 12, the motor rotor 13 and the reduction gear set 15 are arranged in order from left to right. Then the right cover 18 is fixed by the right-cover locking ear 181 thereon and the corresponding housing locking lugs 111 on the housing 11 with fastening screws. However, in practice, the related-art structure has the drawbacks of multiple protruding structures such as the housing locking lugs 111, the left-cover locking lugs 171, and the right-cover locking lugs 181 appearing on the outside thereof, resulting in a larger overall size and a significant increase in weight. Simply put, the power assembly is difficult to conceal (have low sense of presence) due to larger space occupied by the protruding structure and screws with excessive number. Part of appearance of the power assembly is not in harmony with the bicycle to affect the look of the bicycle. The power assembly also increases the weight of the bicycle and greatly reduces the value of the bicycle, it is not ideal and needs improvement.

Based on the above reasons, there is still room for improvement in the related technology. In view of this, the inventor has actively researched, accumulated many years of experience in related product development, and conducted continuous testing and improvement, finally developed the present invention.

### SUMMARY

The main purpose of the present invention is to provide a power assembly for an electric-assisted bicycle. The power assembly integrates the motor drive housing and the reduction gear housing in a threaded manner. The components including the reduction gear set and the driver are encapsulated therein. The motor drive housing and the reduction gear housing are assembled integrally by screwing the threads together to reduce the overall size of the power assemble and lower the weight of the bicycle. Besides, the demand for structural strength and cost for manufacturing the bicycle can be reduced. The travel range of bicycle of the electric-assisted bicycle can be greatly enhanced.

Accordingly, the present invention provides a power assembly for electric-assisted bicycle. The power assembly includes a side cover, a driver, a motor drive housing, a motor stator, a motor rotor, a crankshaft, a reduction gear set, and a reduction gear housing. The driver is installed on the left side of the motor drive housing and covered and fixed by the side cover. The motor drive housing accommodates the motor stator and motor rotor in the right side thereof. The motor rotor is fit to a hollow input shaft center of the drive reduction gear set. The crankshaft is inserted into center of each component of the power assembly and both ends of the crankshaft are connected to the crank and pedal set of the bicycle. Finally, the reduction gear housing and the motor drive housing are integrally screwed together to form the power assembly for electric-assisted bicycle.

The power assembly of the electric-assisted bicycle has separate housing design (the motor drive housing and reduction gear housing). After the above-mentioned components are assembled in sequence, the motor drive housing and the reduction gear housing encapsulate the components to form one body. The special feature is that, in comparison with the related art technology, the present invention has a simple appearance with a simple coaxial circular structure and the present invention has no protruding structures such as screw and locking lugs. The bottom bracket of the vehicle has more flexibility for use and can be designed to be circular hollow space. The power assembly has a low sense of presence and looks secretive from the outside. The weight of the entire bicycle is also greatly reduced, which is matched with the lightweight requirement in bicycle industry.

To further understand the features and technical content of the present invention, please refer to the following detailed description and drawings of the present invention. However, the attached drawings are for reference and illustration only and are not intended to limit the scope of the present invention.

### BRIEF DESCRIPTION OF THE DRAWINGS

FIG. 1 is perspective views of a related-art bicycle auxiliary power assembly for bicycle.

FIG. 1A is cross-sectional view of a related-art bicycle auxiliary power assembly for bicycle.

FIG. 2 is the perspective view of the power assembly for electric-assisted bicycle of the present invention.

FIG. 3 is the sectional view of the power assembly for electric-assisted bicycle of the present invention.

FIG. 4 shows the perspective sectional view of the motor drive housing of the power assembly for the electric-assisted bicycle according to the present invention.

FIG. 5 shows the perspective sectional view of the reduction gear housing of the power assembly for the electric-assisted bicycle according to the present invention.

FIG. 6 shows the exploded perspective view of the components for the power assembly of the present invention.

FIG. 7 is a schematic view showing the application of the power assembly of the present invention.

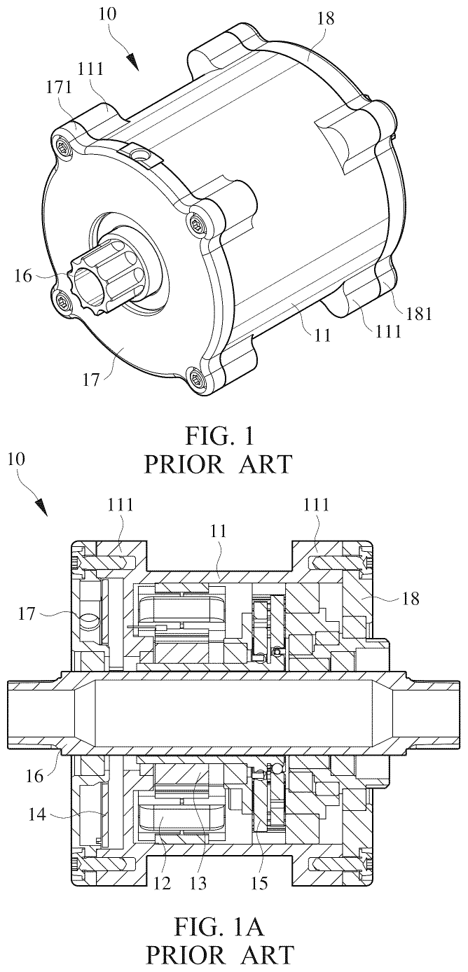

### DETAILED DESCRIPTION

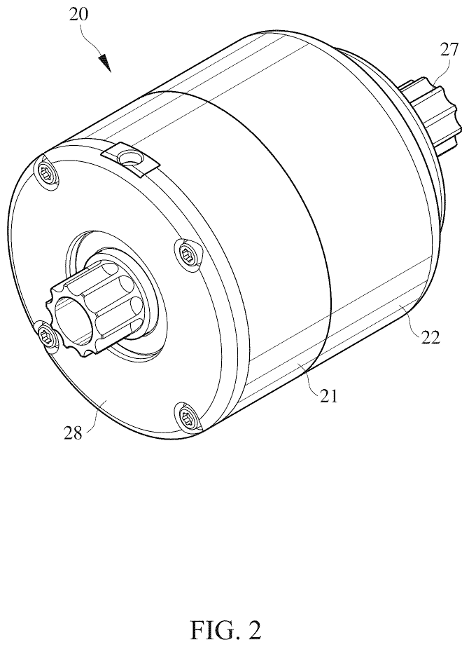

Please refer to FIG. 2 to FIG. 7. The present invention relates to a power assembly 20 of an electric-assisted bicycle. The power assembly includes a side cover 28, a driver 25, a motor drive housing 21, a motor stator 23, a motor rotor 24, a crankshaft 27, a reduction gear set 26, and a reduction gear housing 22. The motor drive housing 21 contains the driver 25 on left internal space thereof, and is sealed and fixed by the side cover 28. The motor drive housing 21 contains the motor stator 23 and the motor rotor 24 on right internal space thereof. The motor rotor 24 drives the hollow input shaft center of the reduction gear set 26. The crankshaft 27 is inserted into the center of each component and integrally forms the power assembly for the electric-assisted bicycle with the motor drive housing 21 and the reduction gear housing 22. Both ends of the crankshaft 27 are connected to the bicycle crank 31 and the pedal 32.

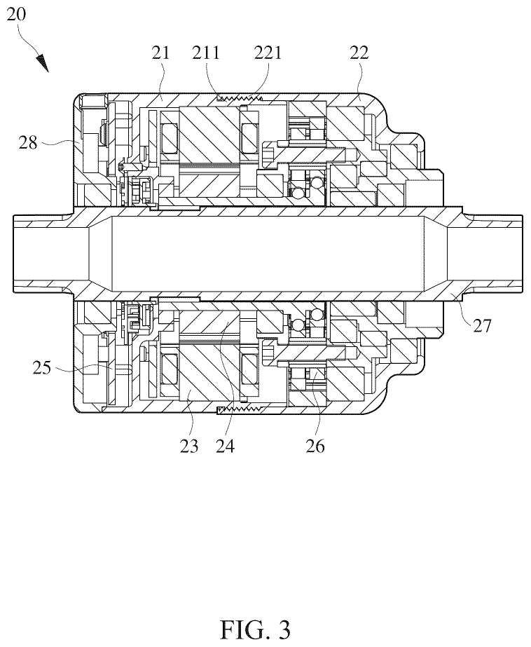

From the perspective view of FIG. 2, it is clearly shown that the power assembly 20 of the present invention is of simply coaxial circular structure from appearance. The power assembly 20 can be matched with the hollow space of the bottom bracket of a bicycle and greatly reduce the size of the hollow space of the bottom bracket. The power assembly 20 enables the bottom bracket to form integral part with the frame to enhance aesthetic effect. With reference also to FIG. 3, this figure shows a cross-sectional view of the power assembly 20 of the electric-assisted bicycle of the present invention and clearly shows the internal structure of the compact power assembly 20 of the present invention. More particularly, the motor drive housing 21 includes a motor drive housing thread 211 arranged on right open end thereof, and the reduction gear housing 22 includes reducer housing thread 221 arranged on left open end thereof. After the internal components are assembled, the reducer housing thread 221 and the motor drive housing thread 211 are screwed together to combine the motor drive housing 21 and the reduction gear housing 22 into one body, thus enclosing the internal components of the power assembly 20 of the present invention.

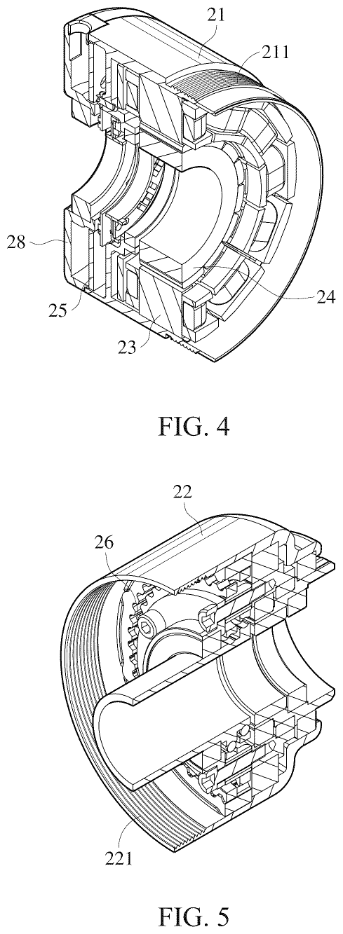

FIG. 4 shows the perspective sectional view of the motor drive housing 21 of the power assembly for the electric-assisted bicycle according to the present invention, and FIG. 5 shows the perspective sectional view of the reduction gear housing 22 of the power assembly for the electric-assisted bicycle according to the present invention. Those drawings clearly show the internal components in the motor drive housing 21 and the internal components in the reduction gear housing 22. The main internal components in the motor drive housing 21 include the side cover 28, the driver 25, the motor stator 23, and the motor rotor 24. The main internal components in the reduction gear housing 22 include the reduction gear set 26. The reduction gear set 26 functions to have high speed rotation at input end and low speed rotation at output end to achieve designed speed-reduction ratio. The assembled power assembly 20 for the electric-assisted bicycle can effectively integrate the motor with the reduction gear set 26. Therefore, the power assembly 20 of the present invention can provide advantages for the space design of bicycle frame and lower the weight of bicycle. Besides, the power assembly 20 of the present invention can have good benefits for vehicle manufacturing cost and battery life.

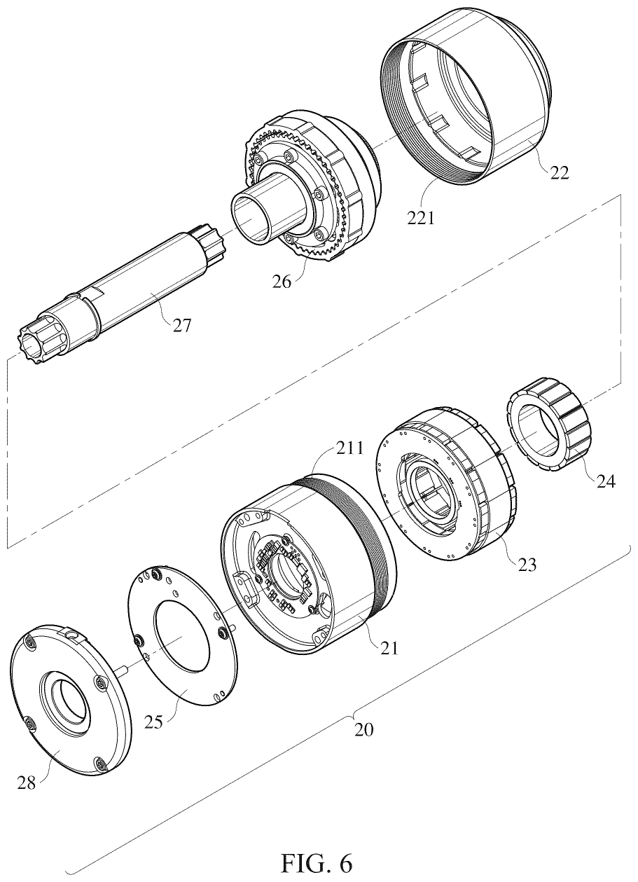

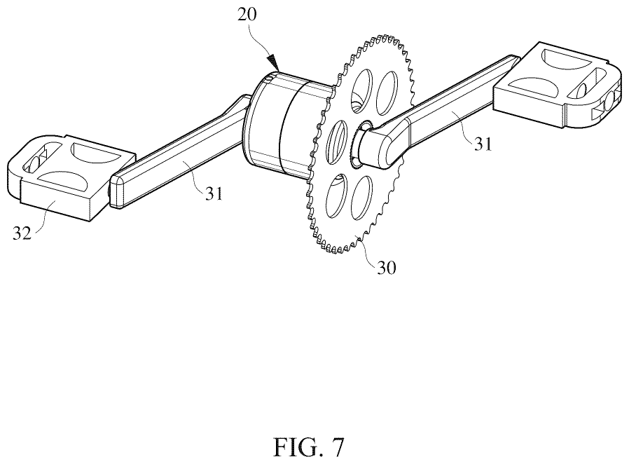

FIG. 6 shows the exploded perspective view of the components for the power assembly 20 of the present invention, and FIG. 7 is a schematic view showing the application of the power assembly 20 of the present invention. As mentioned above, the power assembly 20 of the present invention has advantages of simple shape for the motor drive housing 21 and the reduction gear housing 22 and moving the fixing components such as screws into the internal mechanism. Therefore, the disadvantages in prior art power assembly such as bulky size and heavy weight can be solved. The output shaft end of the reduction gear set 26 has a tooth-shaped structure, and the output end of the reduction gear set 26 is meshed with the tooth disc 30 to output power as auxiliary power. Therefore, when the rider operates the pedal 32 and the crank 31 for manual riding and pedals in the forward direction, the first one-way clutch of the reduction gear set 26 and the output shaft of the reduction gear set 26 are outwardly connected with the tooth disc 30 through the linkage of the crankshaft 27, and the tooth disc 30 derives the bicycle for riding through the chain. When the bicycle is pedaled in reverse direction, the first one-way clutch of the reduction gear set 26 is detached from connection. When there is a speed difference between the motor and human riding, the motor intervenes in power assistance. At this time, the motor rotor 24 drives the hollow input shaft of the reduction gear set 26 and thereby links the internal gears, gear seats and the second one-way clutch. Then the motor rotor 24 drives the output teeth of the reduction gear set 26 to link the tooth disc 30 and drives the bicycle through the chain.

As mentioned in the previous description, “low sense of presence” means that the ride needs to be quiet and smooth; it is best for people to be not aware of their riding an electrically assisted vehicle. More importantly, the central motor should be strong and durable enough, with good dustproof and waterproof performance. Besides, the mid-drive motor should be robust enough to avoid the car owners from worrying about post-maintenance. In the present invention, the power assembly of the electric-assisted bicycle and the durability of the mid-drive motor are also optimized. The power assembly of the electric-assisted bicycle is fixed stably with bicycle in certain way such that the motor can run smoothly, the excessive vibration of the motor system during bumps is reduced, and the noise is effectively suppressed. The motor adopts an encapsulated design to maximize heat dissipation effect and reduce the risk of failure caused by motor overheating.

In summary, in the power assembly of the electric-assisted bicycle of the present invention, the overall size of the power system is reduced, which contributes to flexible and reasonable design arrangements. In addition, the reduction mechanism is used to amplify torque, which can produce greater torque at low speeds. The reduction mechanism not only meets the requirements of flat road cruising, but can also easily cope with long-distance climbing.

It shall be understood that the present invention may have other types of embodiments, and a person with ordinary skills in the art of the technical field of the present invention may make various changes and modifications corresponding to the present disclosure without deviating the principle and substance of the present invention; however, such corresponding changes and modification shall be considered to be within the claimed scope of the present invention.

What is claimed is:

1. A power assembly for electric-assisted bicycle, the power assembly comprising:
a motor drive housing comprising a motor drive housing having a motor drive housing thread at one end thereof;
a motor stator, a motor rotor and a driver arranged inside the motor drive housing;
a reduction gear housing, a reduction gear set arranged inside the reduction gear housing, the reduction gear housing having a reduction gear housing thread at one end thereof;
a crankshaft having regular teeth at both ends thereof;
a side cover being a circular cover, and the side cover being arranged on one side of the motor drive housing;
wherein the motor drive housing and the reduction gear housing are formed into one body by being threaded together to form an encapsulation;
wherein the crankshaft is inserted into an axial center position of each component of the power assembly to form the power assembly for electric-assisted bicycle.

2. The power assembly for electric-assisted bicycle in claim 1, wherein the crankshaft is formed with a hollow axis.
